(19) United States
(12) Patent Application Publication
(10) Pub. No.: US 2006/0061801 A1
(43) Pub. Date: Mar. 23, 2006

(54) System for distributing drawing data

(75) Inventors: Satoshi Watanabe, Mishima-shi (JP); Kazuhiro Kumano, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/943,558

(22) Filed: Sep. 17, 2004

(51) Int. Cl. G06F 15/00

(52) U.S. Cl. 358/1.15

(57) ABSTRACT

A drawing distributing system deals with image data items of drawings as drawing files having file names and containing information items indicating design notices corresponding to the drawings. When information indicating the drawings described on the design notice and drawing files displayed on a display device are collated with each other, check boxes capable of displaying check marks in correspondence to the file names of the drawing files are displayed on the display device.

### BACKGROUND OF THE INVENTION

1. Field of the Invention

This invention relates to a drawing data distributing system which distributes image data of a drawing such as a design drawing which has been converted into electronic data, for example, as a drawing file to a remote place.

2. Description of the Related Art

Conventionally, in a system used to manufacture a product based on a design drawing, the department (drawing designing section) in which a drawing is designed and the department (drawing distribution destination) in which a product is manufactured based on the drawing are different from each other in some cases. In such a system, for example, the design drawing formed in the drawing designing section is managed in a department (drawing managing section) in which the drawing is managed. Further, the drawing which is managed in the drawing managing section is distributed to a distribution destination in a department in which the drawing is distributed to a distribution destination. In the above system, a sheet of paper (design notice) on which a list of a plurality of drawings formed is described is submitted to the drawing managing section together with the plurality of drawings in the drawing design section in many cases. In such cases, in the drawing managing section and drawing issuing section, a series of drawings is subjected to various operations such as arranging, copying, packing and sending operations based on the list of the drawings described on the design notice.

In recent years, in the above system, computerization has is advanced. For example, the drawing is sent to a distribution destination in the form of electronic data (image data). The image data of the drawing is converted into electronic data in the process of development of computerization of the system. However, a design notice on which a list of information items indicating a series of drawings is described is formed of paper in some cases. In such cases, a collating operation is performed to manually confirm excess or deficiency of image data (drawing files) of the drawings by visually observing information indicating the drawings described on the design notice and image data (or file names of image data of the drawings) of the drawings converted into electronic data. That is, it becomes sometimes necessary for a person to perform the operation for collating drawing files displayed on a display of a computer (PC) with information indicating drawings described on a sheet of paper (design notice).

Further, in a list of information items indicating the drawings described on the design notice, information items indicating a large number of drawings over a plurality of pages are described, or information items indicating the drawings which are set not in an order of the drawing names or drawing number but in a desired order are described. Further, distribution destinations are set differently for the respective drawings in some cases. In a case where a large number of drawing files are provided, not all of the drawing files can be simultaneously displayed on the display of the computer in some cases. In such cases, drawing data is displayed over a plurality of screens on the display.

In the above condition, a check mark indicating that the collation process has been performed can be manually entered on the design notice. However, a check mark cannot be manually entered on the display which displays the drawing files. Therefore, in the above system, it becomes difficult to collate information indicating the drawings described on the design notice with the drawing files displayed on the display.

### BRIEF SUMMARY OF THE INVENTION

An object of this invention is to provide a drawing distributing system which can easily and safely perform a collating operation for collating information indicating drawings described on a sheet of paper with drawing files displayed on the display screen of the display device.

A drawing distributing system according to an aspect of the invention is a system which distributes drawings in the form of image data and comprises a first memory in which image data items of a plurality of drawings are stored as drawing files, a display section which displays file names of a plurality of drawing files stored in the first memory and check boxes capable of displaying check marks in correspondence to the respective file names in a list form, an operating section which inputs an instruction to display check marks in the check boxes which correspond to the drawing files displayed on the display section, and a selecting section which selects the drawing file of the drawing to be transmitted to a distribution destination from the drawing files whose file names are displayed on the display section.

A drawing distributing system according to another aspect of the invention is a system comprising a first system which digitizes image data of a drawing, and a second system which transmits the drawing digitized by the first system to a distribution destination, wherein the first system includes a filing system which converts a plurality of drawings into image data items and attaches file names to the image data items of the drawings, a first memory which stores each drawing converted into image data by the filing system as the drawing file of the file name, and the second system includes a display section which displays file names of a plurality of drawing files stored in the first memory and check boxes capable of displaying check marks in correspondence to the respective file names in a list form, an operating section which inputs an instruction to display check marks in the check boxes which correspond to the drawing files displayed on the display section, and a selecting section which selects the drawing file of the drawing to be transmitted to a distribution destination from the drawing files whose file names are displayed on the display section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the whole configuration of an electronic drawing distributing system according to one embodiment of this invention;

FIG. 2 is a flowchart for illustrating a digitizing process which converts (digitizes) a paper drawing into image data;

FIG. 3 is a diagram showing an example of a design notice;

FIG. 4 is a diagram showing an example of file names attached to image data items of the drawings;

FIG. 5 is a flowchart for illustrating a copy process by use of a copy tool;

FIG. 6 is a flowchart for illustrating a selecting process by use of a select tool;

FIG. 7 is a diagram showing an example of a paper design notice on which display indicating drawings is described;

FIG. 8 is a diagram showing a display example in a case where a list of file names of the drawing files is displayed on a display section;

FIG. 9 is a diagram showing an example of a paper design notice on which display indicating drawings is described;

FIG. 10 is a diagram showing a display example in a case where a list of file names of the drawing files is displayed on a display section;

FIG. 11 is a diagram showing an example of a paper design notice on which display indicating drawings is described;

FIG. 12 is a diagram showing a display example in a case where a list of file names of the drawing files is displayed on a display section;

FIG. 13 is a view showing a display example of the display section displayed by the select tool; and

FIG. 14 is a flowchart for illustrating the uploading process by an upload tool,

### DETAILED DESCRIPTION OF THE INVENTION

There will now be described embodiments of this invention with reference to the accompanying drawings.

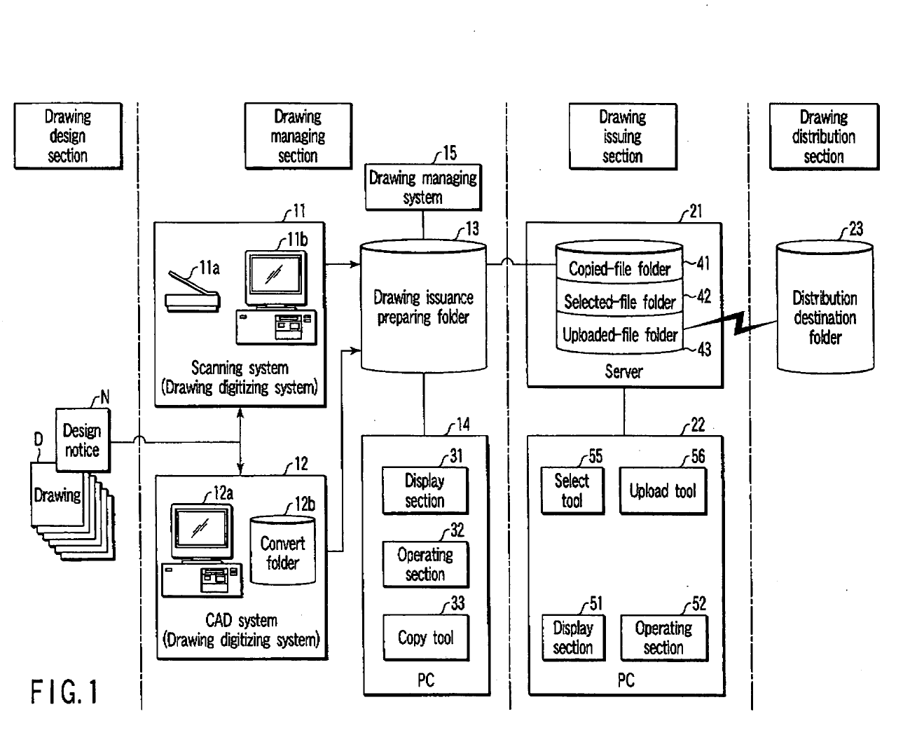

FIG. 1 is a diagram showing the whole configuration of an electronic drawing distributing system according to one embodiment of this invention.

The electronic drawing distributing system shown in FIG. 1 is a system which is installed in an area including a drawing design section, drawing managing section, drawing issuing section and drawing distribution destination, for example.

The drawing design section is a department in which drawings are formed. For example, in a company which manufactures products, the drawing design section corresponds to a product development department or product design department which forms design drawings associated with products or a manufacturing method of products. The drawing managing section is a department which manages drawings formed in the drawing design section. For example, in a company which manufactures products, the drawing managing section corresponds to a clerical work department which deals with clerical work to manage drawings formed in the drawing design section.

The drawing issuing section is a department which distributes the drawings managed in the drawing managing section to the drawing distribution destination. For example, in a company which manufactures products, the drawing issuing section corresponds to a department which manages data or drawings of the whole company. The drawing distribution destination is a department which is a distribution destination of the drawings. For example, in a company which manufactures products, the drawing distribution destination corresponds to a manufacturing department (factory) which manufactures products based on the drawings.

As shown in FIG. 1, the electronic drawing distributing system includes a scanner system 11, CAD system 12, drawing-issuance preparing folder 13, PC 14, drawing managing system 15, server 21, PC 22 and distribution destination folder 23.

First, the drawing design section is explained.

In the drawing design section, a drawing D and design notice N are formed. The drawing D and design notice N are formed according to a change in the design or the like. For example, when a design is changed, the designer of the drawing design section forms one set of drawings configured by a plurality of drawings D. Further, the designer also forms a design notice N on which information indicating drawings configuring one set of formed drawings is described. At this time, the drawing D and design notice N can be formed in a printed form on a sheet of paper or in an electronic data form. The drawing D and design notice N are submitted to the drawing managing section.

Next, the system in the drawing managing section is explained.

As shown in FIG. 1, the system (first system) in the drawing managing section includes the scanner system 11, CAD system 12, drawing-issuance preparing folder 13, PC 14 and drawing managing system 15.

In the drawing managing section, first, the drawing D and design notice N submitted from the drawing design section are converted into image data in a predetermined data form. In the drawing managing section, the paper drawing and paper design notice are converted (digitized) into image data in the predetermined data form by the scanner system 11. Further, the drawing of electronic data and the design notice of electronic data are converted into image data in a predetermined data form by the CAD system 12.

The scanner system 11 functions as a filing system which converts the drawing into an electronic file form. As shown in FIG. 1, the scanner system 11 includes a scanner 11a and PC 11b. The scanner 11a optically reads an image on a sheet of paper and converts the thus read image into image data. The PC 11b is a general personal computer, for example.

In the scanner system 11, the scanner 11a reads the paper drawing D and paper design notice N as image data. The PC 11b converts image data of the drawing D and design notice N read (digitized) by the scanner 11a into a predetermined data form. The PC 11b attaches image data of the drawing D and image data of the design notice N converted into the predetermined data form and stores the same into the drawing-issuance preparing folder 13.

Further, the PC 11b attaches file names to the image data of the respective drawings D and image data of the design notices N according to respective predetermined rules. A person in charge of the drawing managing section inputs the file names by use of the operating section of the PC 11b. That is, in the PC 11b, the person in charge stores the image data (drawing files) of the drawings and image data (design notice files) of the design notices into the drawing-issuance preparing folder 13 by use of the files names attached according to the predetermined rules.

The CAD system 12 functions as a filing system which digitizes image data of the drawing by converting the image data into a predetermined data form. The CAD system 12 includes a PC 12a and conversion folder 12b. The PC 12a is configured by a general personal computer or the like. The PC 12a has a CAD function. The conversion folder 12b is configured by a hard disk drive or the like. The conversion folder 12b is a folder which converts the data form of the image data items of the drawing D and design notice N into a predetermined data form.

In the CAD system 12, the PC 12a reads the drawing D and design notice N in the electronic data form by use of the CAD function. In the CAD function of the PC 12a, electronic data is dealt with in a data form different from the predetermined data form. Therefore, in the PC 12a, image data of the drawing D and image data of the design notice N are converted into a predetermined data form by use of the conversion folder 12b. The image data of the drawing D and image data of the design notice N which are converted into a predetermined data form by use of the conversion folder 12b are stored into the drawing-issuance preparing folder 13.

Further, the PC 12a attaches file names corresponding to predetermined rules to the image data of the drawing D and image data of the design notice N. The file names are input by the person in charge of the drawing managing section by using the operation panel of the PC 12a. That is, the PC 12a stores the image data (drawing files) of the drawings and image data (design notice files) of the design notices into the drawing-issuance preparing folder 13 by file names attached according to the predetermined rules.

The drawing-issuance preparing folder 13 stores the image data of the drawings D and design notices N which are unified in the predetermined data form as the drawing files and design notice files. As described before, the drawing files and design notice files are stored in the drawing-issuance preparing folder 13 based on the file names according to the predetermined rules.

Further, for example, the drawing-issuance preparing folder 13 is provided in the storage device incorporated in the PC or server computer (not shown). The drawing-issuance preparing folder 13 can be accessed from the scanner system 11, CAD system 12, PC 14, drawing managing system 15 and the like. The files of the drawing-issuance preparing folder 13 can be transferred into copied-file folder in the server 21 under control of the PC 14. The drawing-issuance preparing folder 13 can be provided in the server 21.

The PC 14 performs the process for the files (drawing files and design notice files) in the drawing-issuance preparing folder 13. The PC 14 is configured by a general personal computer. The PC 14 includes a display section 31, operating section 32 and copy tool 33. The copy tool 33 is a function performed by causing a control section (not shown) in the PC 14 to execute an application program stored in a memory (not shown) in the PC 14. The copy tool 33 extracts the drawing file in the drawing-issuance preparing folder 13 based on information indicating the design notice and copies the extracted drawing file into the copied-file folder 41 of the server 21.

The drawing managing system 15 is a system which manages the drawing files and design notice files in the drawing-issuance preparing folder 13. In the drawing managing section, the files stored in the drawing-issuance preparing folder 13 are managed by the drawing managing system 15.

Next, the system in the drawing issuing section is explained.

As shown in FIG. 1, the system (second system) in the drawing issuing section is configured by the server 21 and PC 22.

The server 21 is configured by a server computer and the like. The server 21 includes a copied-file folder 41, selected-file folder 42 and uploaded-file folder 43. In the copied-file folder 41, files processed by the copy tool are stored. In the selected-file folder 42, files processed by a select tool which will be described later are stored. In the uploaded-file folder 43, files processed by an upload tool which will be described later are stored.

The PC 22 has the configuration of a general personal computer. The PC 22 performs the processes for the files stored in the folders 41, 42, 43 of the server 21. For example, the PC 22 selects the file in the server 21 and distributes (transmits) the selected file to the distribution destination folder 23.

The PC 22 includes a display section 51, operating section 52, select tool 55 and upload tool 56. The select tool 55 and upload tool 56 are functions realized by causing a control section (not shown) of the PC 22 to execute an application program stored in a memory (not shown) of the PC 22.

The select tool 55 is a tool which selects a drawing file stored in the copied-file folder 41. In the select tool 55, whether each drawing file is to be deleted or transmitted (uploaded) is determined. The upload tool 56 is a tool which transmits the drawing file stored in the selected-file folder and subjected to the selecting process to the distribution destination.

The select tool 55 and upload tool 56 are explained in detail later. Further, in the configuration of FIG. 1, the PC 22 implements various tools in the drawing issuing section, but the above tools can be implemented by use of a plurality of PCs.

Next, the operation example of the electronic drawing distributing system with the above configuration is explained.

First, the process in the drawing managing section is explained.

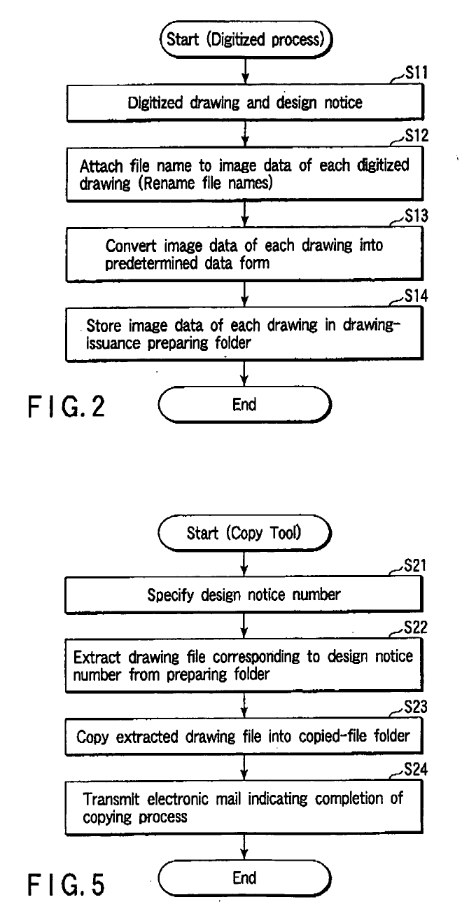

FIG. 2 is a flowchart for illustrating a digitizing process which converts a drawing D formed in the drawing design section into electronic data (image file) of the drawing.

First, the person in charge of the drawing managing section receives a plurality of drawings D formed by a designer in the drawing design section and design notices N corresponding to the drawings D. In this case, it is assumed that the person in charge of the drawing managing section receives paper drawings D and design notices N from the designer. Therefore, the person in charge of the drawing managing section who has received the paper drawings D and design notices N digitizes the drawings D and design notices N by use of the scanner system 11.

First, the scanner 11a of the scanner system 11 reads the drawing D and design notice N set by the person in charge of the drawing managing section. That is, the scanner 11a optically reads an image of each drawing D and an image of each design notice N and converts the read images into image data (step S11).

File names are attached to the image data items of the drawing and design notice read by the scanner 11a by use of the PC 11b and the thus obtained image data items are converted into a predetermined data form and stored in the drawing-issuance preparing folder 13. For example, this is attained by causing the person in charge of the drawing managing section to issue an instruction to input file names, select a data form and hold (store) the files into the drawing-issuance preparing folder 13 by use of the operating section of the PC 11b.

That is, a file name is attached to the image data read by the scanner 11a by the PC 11b which is operated by the person in charge of the drawing managing section (step S12). If a desired file name is attached to the image data read by the scanner 11a, the file name of each drawing is renamed in the step S12.

The file name attached to the image data of each drawing D in the step S12 is determined according to a predetermined rule. Further, in the present embodiment, it is assumed that the file name of the image data of each drawing contains a number (design notice number) indicating a design notice corresponding to the drawing. The reason is to permit the corresponding design notice to be easily identified based on the file name. As a result, the PC can determine the design notice corresponding to the drawing based on the design notice number contained in the file name or extract image data of a drawing corresponding to a specified design notice from image data items of a plurality of drawings. A design notice number or a file name containing the design notice number is attached to image data of the design notice N.

Now, an example of a file name attached to image data of a drawing is explained.

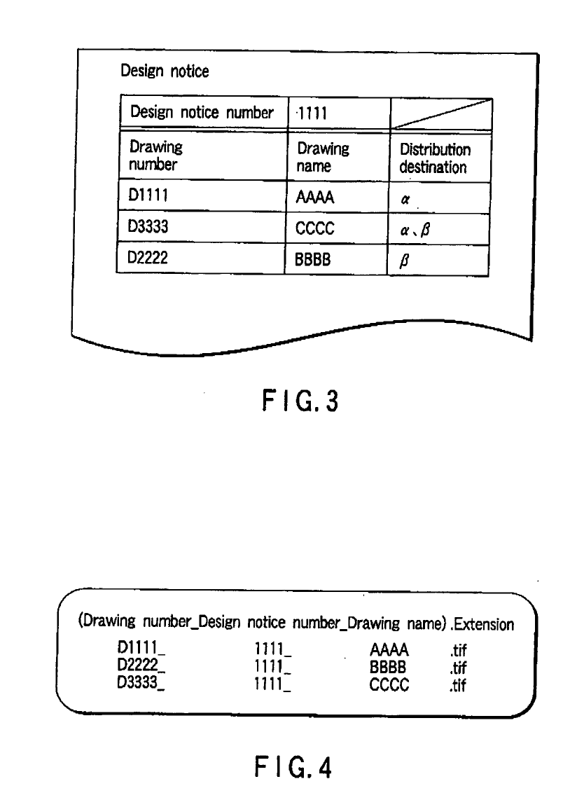

FIG. 3 is a diagram showing an example of the design notice N. FIG. 4 shows an example of a file name attached to image data of a drawing corresponding to the design notice N of FIG. 3.

In the design notice N shown in FIG. 3, a design notice number, drawing numbers, drawing names and distribution destinations of drawings are described. In the design notice N of FIG. 3, the design notice number is “1111”, the drawing numbers of the drawings are “D1111, D3333, D2222”, the drawing names of the drawings are “AAAA, CCCC, BBBB”, and the distribution destinations of the drawings are “α, α and β, β”. The above design notice number, drawing numbers, drawing names and distribution destinations are information items attached at the time of designing the drawings. The design notice number is set to a number different from a design notice number of another design notice. Further, the drawing numbers and drawing names may be the same as those used in another design notice.

The file name of each drawing shown in FIG. 4 is configured to include “drawing number_design notice number_drawing name. extension (extension in a predetermined data form)” for the design notice N shown in FIG. 3. That is, not only the design notice number but also the drawing number and drawing name indicated by the design notice are contained in the file name of each drawing. By thus forming the file name according to the above rule, identification information of a corresponding drawing and design notice can be determined in the file of each drawing.

If the above file name is attached, the PC 11b converts image data of each drawing and image data of the design notice into image data in a predetermined data form (step S13). The conversion process for the data form of image data can be performed by using an application program installed in the PC 11b. The data form of image data of the drawing is indicated by an extension in the file name of the image data of each drawing.

If the image data of each drawing and image data of the design notice are converted into the predetermined data form, the PC 11b holds the image data of each drawing and image data of the design notice as the file (drawing file and design notice file) of the file name attached in the step S12 in the drawing-issuance preparing folder 13 (step S14).

By performing the above process, the drawings and the design notice submitted from the drawing design section are stored as files of image data in the predetermined data form in the drawing-issuance preparing folder 13 by file names according to the predetermined rule by the drawing managing section.

In a case where the image data items of the drawings and design notice are stored in the drawing-issuance preparing folder 13 via the CAD system 12, file names according to the above rule are attached to the image data items of the drawings and design notice by the PC 12a of the CAD system 12. Then, the above image data items are converted into a predetermined data form and converted into a file form by use of the conversion folder 12b and then stored in the drawing-issuance preparing folder 13.

Next, the process performed by the copy tool 33 is explained.

In the drawing managing section, when the drawing files and design notice file are stored in the drawing-issuance preparing folder 13, the drawing files and design notice file which are stored in the drawing-issuance preparing folder 13 are transferred to the drawing issuing section by use of the copy tool 33 of the PC 14. In other words, the copying process by the copy tool 33 is a drawing file management process in the drawing managing section. The copy tool 33 performs the copying process to copy the drawing files and design notice file corresponding to a specified design notice number and contained in the drawing files and design notice files held in the drawing-issuance preparing folder 13 into the copied-file folder 41 of the server 21.

FIG. 5 is a flowchart for illustrating the copying process by use of the copy tool 33.

That is, the person in charge of the drawing managing section starts the operation of the copy tool 33 of the PC 14. When the copy tool 33 is executed, the person in charge specifies a design notice number corresponding to the drawing which is to be subjected to the copying process by the operating section 32. When the design notice number is specified by the operating section 32 (step S21), the copy tool 33 extracts the drawing files corresponding to the specified design notice number from the drawing-issuance preparing folder 13 (step S22). As described above, in the drawing-issuance preparing folder 13, the drawing files are held by file names containing the design notice number, and the design notice files are also held by file names containing the design notice number. Therefore, the copy tool 33 extracts the drawing files and design notice file according to the file name based on the specified design notice number.

When the drawing files and design notice file corresponding to the specified design notice number are extracted from the drawing-issuance preparing folder 13, the copy tool 33 copies the drawing files and design notice file extracted from the drawing-issuance preparing folder 13 into the copied-file folder 41 of the server 21 (step S23). At this time, the copy tool 33 transmits an electronic mail indicating the copied drawings and design notice to the PC 22 of the drawing issuing section (the person in charge of the drawing issuing section) (step S24). Thus, the person in charge of the drawing issuing section can recognize that the drawing files and design notice to be issued from the drawing managing section have been copied into the copied-file folder 41.

Next, the process in the drawing issuing section is explained.

In the drawing issuing section, the selecting process, uploading process and the like are performed for the drawing files and design notice file held in the server 21. In this case, the selecting process and uploading process are respectively performed by a select tool 55 and upload tool 56 of the PC 22.

Next, the process by the select tool 55 is explained.

The selecting process by the select tool 55 is a process to confirm each drawing file corresponding to the design notice N and determine whether each drawing file is transmitted or deleted. In this example, the following explanation is made on the assumption that the design notice N is printed on paper. That is, in the selecting process, whether the drawing file is transmitted or deleted is determined while confirming the drawings described on the design notice N.

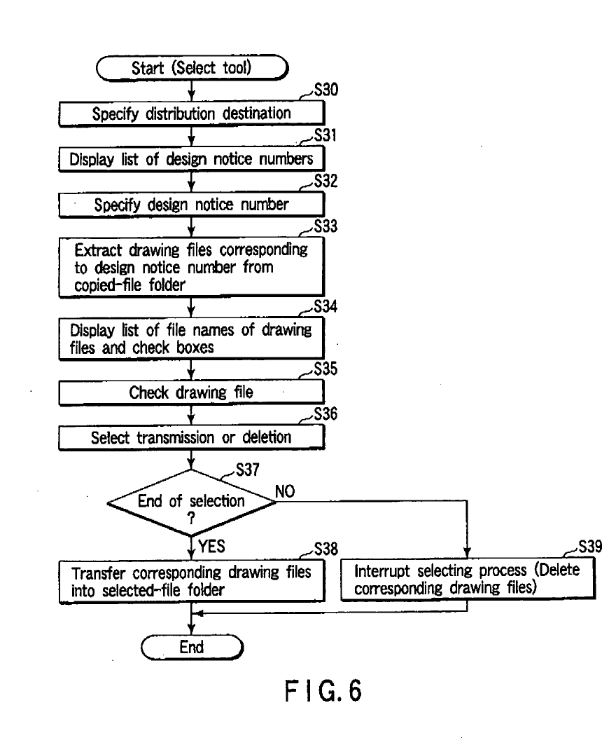

FIG. 6 is a flowchart for illustrating the selecting process by use of the select tool 55.

The person in charge of the drawing issuing section recognizes the drawing files and design notice file copied in the copied-file folder 41 by the copying process by use of the electronic mail from the drawing managing section. Then, the person in charge of the drawing issuing section executes the select tool 55 of the PC 22. When the select tool 55 is executed, the person in charge specifies a distribution destination by use of the operating section 52. If the distribution destination is specified (step S30), the select tool 55 displays a list of the design notice numbers lying in the copied-file folder 41 on the display section 51 (step S31). The person in charge specifies the design notice number to be subjected to the selecting process from the list of the design notice numbers displayed on the display section 51 by use of the operating section 52.

If the design notice number is specified (step S32), the select tool 55 extracts all of the drawing files corresponding to the specified design notice number from the copied-file folder 41 (step S33). As described before, in the copied-file folder 41, the drawing files are held by file names containing the design notice numbers. Therefore, the select tool 55 extracts the drawing files of the file names containing the specified design notice number.

If the drawing files corresponding to the specified design notice number are extracted, the select tool 55 displays a list of file names of all of the files of the drawings extracted from the copied-file folder 41 and check boxes corresponding to the file names on the display section 51 (step S34). In the check box, a check mark can be input by use of the operating section 52. Further, the presence or absence of the check mark in the check box is not related to a later process. Therefore, the person in charge can freely input a check mark into the check box.

In the above display condition, an excess or deficiency of the drawing files whose file names are displayed on the display section 51 is checked (step S35). For example, the person in charge collates the drawing numbers and drawing names described on the paper design notice N with the drawing numbers and drawing names displayed as the file names on the display section 51,

The collating process is to check the excess or deficiency of the drawing files (that is, the drawing files existing in the copied-file folder 41) displayed on the display section 51 with respect to the list of information items indicating the drawings described on the design notice N. Further, the collating process for the information items indicating the drawings described on the design notice N and the drawing files displayed on the display section 51 is performed by permitting the person in charge to enter a check mark on the design notice N and display the check mark in the check box of the file name of a corresponding drawing file, for example.

Further, transmission or deletion of each drawing file whose file name is displayed on the display section 51 is selected (step 536). For example, the person in charge specifies deletion or transmission of a drawing file whose file name is displayed on the display section 51 to the distribution destination by use of the operating section 52. The select tool 55 determines deletion or transmission of each drawing file based on the specification made by the person in charge by use of the operating section 52. If the above selecting process is performed for each drawing file, the person in charge specifies the end of the selecting process by use of the operating section 52.

If the end of the selecting process is specified (“YES” in the step S37), the select tool 55 transfers the drawing files displayed in a list form on the display section 51 (that is, drawing files corresponding to the design notice number) from the copied-file folder 51 to the selected-file folder 42 (step S38).

If it is determined in the checking process of the drawing files in the step S35 that the drawings are excessive or deficient, the person in charge specifies canceling of the selecting process for the drawing files displayed on the display section 51. Further, the person in charge who has specified canceling of the selecting process because of excess or deficiency of the drawings notifies the designer of the drawings of the excess or deficiency of the drawings. In this case, the PC 22 may notify the designer of the drawings of the excess or deficiency of the drawings by using an electronic mail.

If canceling of the selecting process is specified (“NO” in the step S37), the select tool 55 interrupts the selecting process for the drawing files displayed on the display section 51 (drawing files corresponding to the specified design notice number) (step S39).

Further, when the selecting process is interrupted (“NO” in the step S37), the select tool 55 may delete. the drawing files displayed on the display section 51 (drawing files corresponding to the specified design notice number) from the copied-file folder 41 or the like (step S39). Thus, occurrence of drawing files having the same design notice number and the same file name can be prevented when the process for the corresponding drawing is performed again.

According to the above selecting process, whether a drawing described on the paper design notice is correctly converted into a drawing file or not can be stably determined. Further, since the check boxes into which the operator can freely input check marks are displayed in correspondence to the file names, the confirming operation by the operator can be supported by observing the check boxes. As a result, the drawing files can be stably checked and occurrence of a confirmation error can be prevented.

Next, an example of the collation procedure of the design notice N with the drawing files as the checking process for the drawing files in the step S35 is explained.

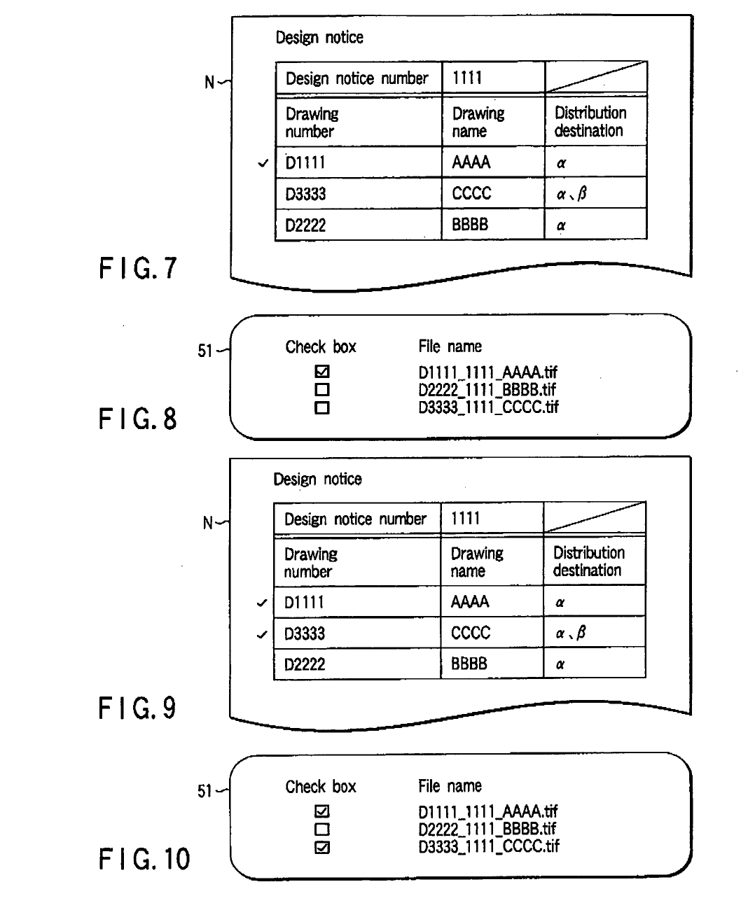

FIGS. 7, 9 and 11 are diagrams showing examples of a design notice on which symbols indicating drawings are described on paper. Further, FIGS. 8, 10 and 12 are diagrams showing display examples when a list of the file names of the drawing files collated with the design notice N of FIGS. 7, 9 and 11 is displayed on the display section 51.

That is, it is assumed that the drawings described on the design notice as shown in FIG. 7, 9 or 11 are collated with the drawing files displayed on the display screen as shown in FIG. 8, 10 or 12.

First, the drawing having the drawing number “D1111” and drawing name “AAAA” described on the design notice N is set to correspond to the drawing file having the file name “D1111_{—}1111_AAAA.tif” displayed on the display section 51. Therefore, the operator manually inputs a check mark in correspondence to the drawing having the drawing number “D1111” and drawing name “AAAA” described on the design notice N as shown in FIG. 7. At this time, as shown in FIG. 8, the operator inputs a check mark into the check box corresponding to the drawing file having the file name “D1111_{—}1111_AAAA.tif” displayed on the display section 51. As a result, the operator can confirm the drawing file corresponding to the drawing having the drawing number “D1111” and drawing name “AAAA”.

Further, the drawing having the drawing number “D3333” and drawing name “CCCC” described on the design notice N is set to correspond to the drawing file having the file name “D3333_{—}1111_CCCC.tif” displayed on the display section 51. Therefore, the operator manually inputs a check mark in correspondence to the drawing having the drawing number “D3333” and drawing name “CCCC” described on the design notice N as shown in FIG. 9. At this time, as shown in FIG. 10, the operator inputs a check mark into the check box corresponding to the drawing file having the file name “D3333_{—}1111_CCCC.tif” displayed on the display section 51. As a result, the operator can confirm the drawing file corresponding to the drawing having the drawing number “D3333” and drawing name “CCCC”.

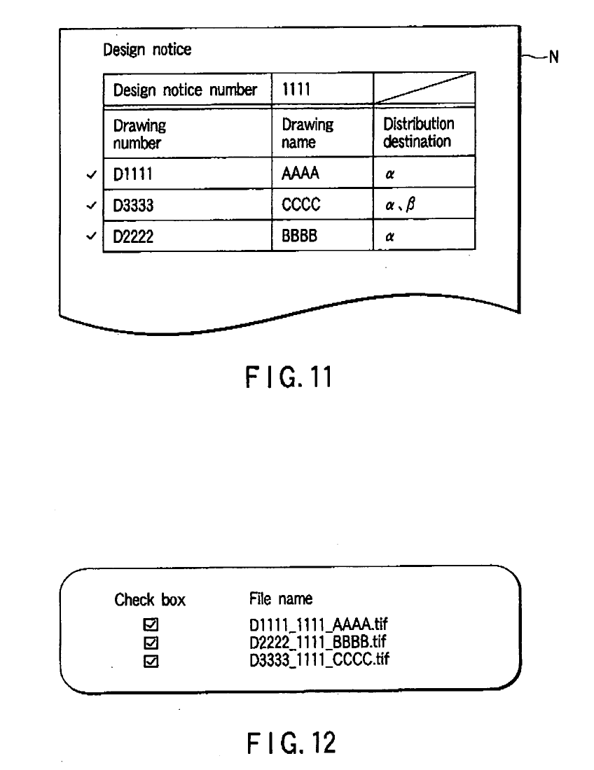

Further, the drawing having the drawing number “D2222” and drawing name “BBBB” described on the design notice N is set to correspond to the drawing file having the file name “D2222_{—}1111_BBBB.tif” displayed on the display section 51. Therefore, the operator manually inputs a check mark in correspondence to the drawing having the drawing number “D2222” and drawing name “BBBB” described on the design notice N as shown in FIG. 11. At this time, as shown in FIG. 12, the operator inputs a check mark into the check box corresponding to the drawing file having the file name “D2222_{—}1111_AAAA.tif” displayed on the display section 51. As a result, the operator can confirm the drawing file corresponding to the drawing having the drawing number “D2222” and drawing name “BBBB”.

As described above, in order to correctly collate a drawing name as information indicating a drawing described on the design notice (paper) with the file name of a drawing file as image data of a drawing which is digitized, check marks indicating that the collation process is completed are attached to both of the names and this is the safe and simplest method. However, in the conventional system, it is impossible to manually input a “collated” mark in correspondence to the file name of the drawing file on the display screen of the display section although it is possible to manually input a “collated” mark in correspondence to the drawing name of the drawing on the paper design notice.

In the present embodiment, check boxes used to display check marks in response to input of instructions by the operator in correspondence to the file names of the drawing files are displayed on the screen of the display section which displays the file names of the drawing files. Thus, the operator can input a check mark corresponding to the collation result into the check box corresponding to each file name. As a result, the collating operation can be correctly and easily performed to collate the drawing names as information indicating the drawings described on the design notice (paper) with the file names of the drawing files as image data of the digitized drawings.

Next, a display example of the display section 51 displayed by the select tool 55 is explained.

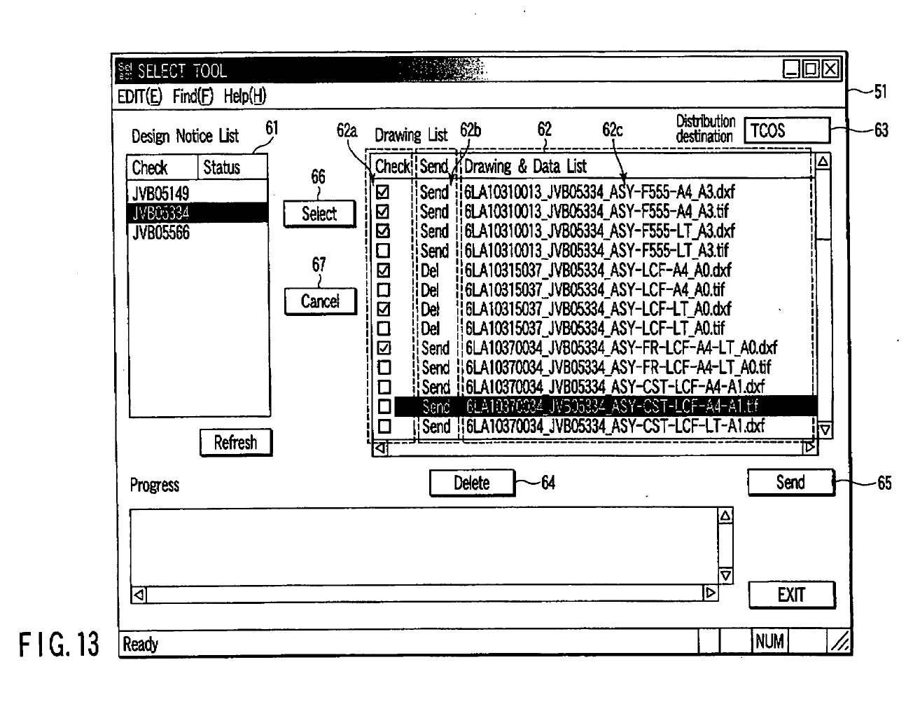

FIG. 13 is a view showing a display example of the display section 51 displayed by the select tool 55. In the display example shown in FIG. 13, a design notice list display column 61, drawing file list display column 62, distribution destination display column 63, delete button 64, send button 65, select button 66 and cancel button 67 are displayed.

In the list display column 61, the design notices of a list form which can be subjected to the selecting process are displayed by design notice numbers. The operator selects one of the design notice numbers displayed in the list display column 61 by use of the operating section 52. Thus, the design notice number is specified.

In the list display column 62, the drawing files of a list form corresponding to the selected design notice number are displayed by file names. The list display column 62 includes a check box display column 62a, selected state display column 62b and display column 62c of the file names of the drawing files.

In the display column 62a, check boxes corresponding to the file names of the drawing files are displayed. In a check box, a check mark can be displayed in response to input by the operator by use of the operating section 52. Further, the presence or absence of a check mark in the check box is dealt with as information which is not related to the process for the drawing file. As a result, the operator can freely input a check mark into the check box.

In the display column 62b, information indicating the selection state (transmission or deletion) corresponding to the file names of the drawing files is displayed. For example, if “Send” is displayed, the drawing file is a drawing file to be distributed (transmitted) to the distribution destination. Further, if “Del” is displayed, the drawing file is a drawing file which is not to be transmitted to the distribution destination.

In the display column 62c, file names of the drawing files corresponding to the specified design notice number are displayed. The file name of a drawing file displayed in the display column 62c includes a specified design notice number and information such as a drawing name or drawing number which specifies a drawing. In the example shown in FIG. 13, the file name of the drawing file includes a design notice number, drawing name and drawing number.

In the distribution destination display column 63, information indicating a location selected as a distribution destination is displayed. The operator specifies whether each drawing file is transmitted or deleted according to the distribution destination displayed in the display column 63 by use of the operating section 52.

The delete button 64 is a button which is operated when deletion of a drawing file is selected. When a drawing file is to be deleted, the operator operates the delete button 64 while a desired drawing file is kept set in the selected state (the reverse display state in the display example of FIG. 13) by use of the operating section 52. As a result, deletion of the drawing file is selected. In this case, the drawing file is displayed as “Del (Delete)” in the display column 62b.

The send button 65 is a button which is operated when transmission of a drawing file is selected. When a drawing file is to be transmitted, the operator operates the send button 65 while a desired drawing file is kept set in the selected state (the reverse display state in the display example of FIG. 13) by use of the operating section 52. As a result, transmission of the drawing file to the distribution destination is selected. In this case, the drawing file is displayed as “Send” in the display column 62b.

The select button 66 is a button which is operated when the selecting process is completed. When selection for each drawing file is completed (that is, when the selecting process for all of the drawing files corresponding to the specified design notice number is completed), the operator operates the select button 66. As a result, the select tool 55 correctly terminates the selecting process for the drawing files of the specified design notice number.

The cancel button 67 is a button which is operated to interrupt the selecting process for the drawing files of the specified design notice number. When the selecting process is interrupted (for example, when excess or deficiency of the drawing files corresponding to the specified design notice number is detected), the operator operates the cancel button 67. As a result, the select tool 55 interrupts the selecting process for the drawing files of the specified design notice number.

Next, the process by the upload tool 56 is explained.

In the drawing issuing section, the drawing files selected by the select tool, that is, the drawing files held in the selected-file folder 42 are transmitted to the distribution destination by the upload tool 56 of the PC 22. The uploading process by the upload tool 56 is a drawing file issuing process in the drawing issuing section. That is, the upload tool 56 uploads the drawing files and design notice file corresponding to the specified design notice number among the drawing files and design notice files held in the selected-file folder 42 into the distribution destination folder 23.

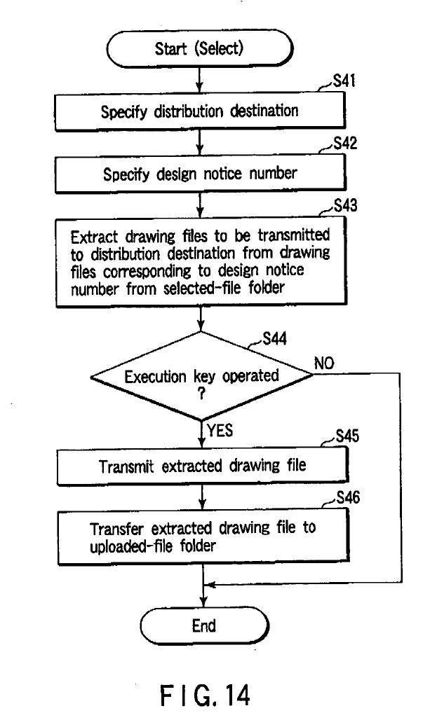

FIG. 14 is a flowchart for illustrating the upload process by use of the upload tool 56.

First, the person in charge of the drawing issuing section executes the upload tool 56 of the PC 22. When the upload tool 56 is executed, the person in charge specifies a distribution destination of the drawing files by use of the operating section 52. When the distribution destination is specified (step S41), the upload tool 56 displays a list of the design notice numbers existing in the selected-file folder 42 on the display section 51.

Thus, the person in charge selects and specifies a design notice number which is to be subjected to the uploading process from the list of the design notice numbers displayed on the display section 51 by use of the operating section 52. When the design notice number is specified (step S42), the upload tool 56 extracts the drawing files which are selected to be distributed (“Send”) to the specified distribution destination and contained in the drawing files corresponding to the specified design notice number from the selected-file folder 42 (step S43). As described above, in the selected-file folder 42, the drawing files are stored by file names containing design notice numbers. In this case, transmission or not is selected for each drawing file.

If the drawing files corresponding to the specified design notice number and to be transmitted to the specified distribution destination are extracted, the upload tool 56 transmits the drawing files in response to operation of an execution button (not shown) by the person in charge,

That is, if the execution button which is used by the person in charge to instruct execution of the uploading operation by using the operating section 52 is operated (“YES” in the step S44), the upload tool 56 uploads (transmits) the drawing files extracted from the selected-file folder 42 and the design notice file of the specified design notice number into the distribution destination folder 23 of the specified distribution destination. At this time, the upload tool 56 transfers the uploaded drawing files and design notice file from the selected-file folder 42 to the uploaded-file folder 43 (step S45).

By the above uploading process, the selected drawing files held in the selected-file folder 42 are transmitted to the distribution destination and then the transmitted drawing files are transferred to the uploaded-file folder 43 (step S46). Thus, only the selected drawing files can be distributed to the distribution destination without fail and the distributed drawing files can be transferred to the uploaded-file folder which is different from that of the selected drawing files.

In the present embodiment, one example of the hardware configuration of the drawing distributing system is shown. However, the drawing distributing system explained in the present embodiment can be realized by use of various hardware configurations. For example, in FIG. 1, the drawing-issuance preparing folder 13 can be provided in a server which is provided separately from the server 21. Further, in the drawing managing section, a plurality of PCs each having the configuration of the PC 14 may be provided. In the drawing issuing section, a plurality of PCs each having the same configuration as the PC 22 may be provided. Further, any type of scanning system and CAD system can be used if image data items of the drawings in a predetermined data for can be held in the drawing-issuance preparing folder 13 as the drawing files by file names according to the predetermined rules. As the hardware configurations thereof, various configurations can be made.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A drawing distributing system which distributes drawings in an image data form, comprising:
a first memory in which image data items of a plurality of drawings are stored as drawing files,
a display section which displays file names of a plurality of drawing files stored in the first memory and check boxes capable of displaying check marks in correspondence to the respective file names in a list form,
an operating section which inputs instructions to display check marks in the check boxes which correspond to the drawing files displayed on the display section, and
a selecting section which selects the drawing files of the drawings to be transmitted to a distribution destination from the drawing files whose file names are displayed on the display section.

2. The drawing distributing system according to claim 1, wherein whether a check mark is present in each check box displayed on the display section has nothing to do with a process for each drawing file.

3. The drawing distributing system according to claim 1, wherein the display section displays file names of drawing files extracted from the first memory based on the specified condition and check boxes capable of freely displaying check marks in correspondence to the file names in a list form.

4. The drawing distributing system according to claim 1, wherein the drawings stored as the drawing files in the first memory are classified according to a list of information items indicating drawings described on a notice and the file names of the drawing files stored in the first memory contain information items indicating corresponding notices.

5. The drawing distributing system according to claim 4, wherein the display section displays file names of all of the drawing files that contain information indicating a specified notice and are extracted from the first memory based on information indicating the specified notice and check boxes capable of freely displaying check marks in correspondence to the file names in a list form.

6. The drawing distributing system according to claim 1, wherein the selecting section interrupts a selecting process when it is detected that drawing files whose file names are displayed on the display section are not provided in a proper quantity.

7. The drawing distributing system according to claim 1, wherein the selecting section deletes drawing files whose file names are displayed on the display section when it is detected that the drawing files whose file names are displayed on the display section are not provided in a proper quantity.

8. The drawing distributing system according to claim 1, further comprising a filing system which converts a plurality of drawings into image data, attaches file names to the image data items of the respective drawings to form drawing files and store the drawing files in the first memory.

9. The drawing distributing system according to claim 1, further comprising a second memory which stores drawing files which have been subjected to a selection process by the selecting section,
wherein the selecting section transfers the drawing files which have been subjected to the selection process from the first memory to the second memory.

10. The drawing distributing system according to claim 1, further comprising an upload section which uploads to-be-transmitted drawing files stored in the second memory to the distribution destination.

11. A drawing distributing system comprising:
a first system which digitizes image data of a drawing, and
a second system which transmits the drawing digitized by the first system to a distribution destination,
wherein the first system includes:
a filing system which converts a plurality of drawings into image data items and respectively attaches file names to the image data items of the drawings, and
a first memory which stores each drawing converted into image data by the filing system as a drawing file of the file name, and
the second system includes:
a display section which displays file names of a plurality of drawing files stored in the first memory and check boxes capable of displaying check marks in correspondence to the respective file names in a list form,
an operating section which inputs instructions to display check marks in the check boxes which correspond to the drawing files displayed on the display section, and
a selecting section which selects the drawing files of the drawings to be transmitted to a distribution destination from the drawing files which are displayed by file names on the display section.

12. The drawing distributing system according to claim 11, wherein whether a check mark is present in each check box displayed on the display section of the second system has nothing to do with a process for each drawing file corresponding to each check box.

13. The drawing distributing system according to claim 11, wherein the display section of the second system displays file names of the drawing files extracted from the first memory based on a specified condition and check boxes capable of freely displaying check marks in correspondence to the file names in a list form.

14. The drawing distributing system according to claim 11, wherein drawings stored as drawing files in the first memory are classified according to a list of information items indicating drawings described on a notice and the filing system of the first system attaches file names containing information items indicating corresponding notices to image data items of the drawings.

15. The drawing distributing system according to claim 14, wherein the display section of the second system displays file names of all of the drawing files that contain information indicating a specified notice and are extracted from the first memory based on information indicating the specified notice and check boxes capable of freely displaying check marks in correspondence to the file names in a list form.

16. The drawing distributing system according to claim 11, wherein the selecting section of the second system interrupts a selecting process when it is detected that drawing files whose file names are displayed on the display section are not provided in a proper quantity.

17. The drawing distributing system according to claim 11, wherein the selecting section of the second system deletes drawing files whose file names are displayed on the display section when it is detected that the drawing files whose file names are displayed on the display section are not provided in a proper quantity.

18. The drawing distributing system according to claim 11, wherein the second system further includes a second memory which stores drawing files which have been subjected to a selection process by the selecting section,
wherein the selecting section of the second system transfers the drawing files which have been subjected to the selection process from the first memory to the second memory.

19. The drawing distributing system according to claim 11, wherein the second system further includes an upload section which uploads to-be-transmitted drawing files stored in the second memory to the distribution destination.
